(19) United States
(12) Patent Application Publication
(10) Pub. No.: US 2017/0190246 A1
(43) Pub. Date: Jul. 6, 2017

(54) SPEED TRANSMISSION DEVICE FOR MOVING A MOTOR VEHICLE, NOTABLY A TWO-WHEELED MOTOR VEHICLE

(71) Applicant: IFP Energies nouvelles, Rueil-Malmaison Cedex (FR)

(72) Inventor: Stephane VENTURI, ROIFFIEUX (FR)

(21) Appl. No.: 15/315,677

(22) PCT Filed: May 29, 2015
(86) PCT No.: PCT/EP2015/062022

§ 371 Date: Dec. 1, 2016

(30) Foreign Application Priority Data
Jun. 2, 2014 (FR) 1454987

(51) Int. Cl. B60K 6/547; F16H 3/091; B60K 6/36; B60K 6/383; B60K 6/387; B60K 6/48; F16H 3/10; F16H 37/02

(52) U.S. Cl. CPC B60K 6/547; F16H 3/10; F16H 3/091; F16H 37/02; B60K 6/383; B60K 6/387; B60K 6/48; B60K 6/36; B60Y 2200/12; B60Y 2200/92; Y10S 903/909; Y10S 903/919

(57) ABSTRACT

The present invention relates to a transmission for two wheeled motor vehicles, comprising a drive shaft (12) carrying at least two driving toothed wheels (14, 16), a driven shaft (38) carrying at least two driven toothed wheels (40, 42) and an intermediate motion transmission shaft (32) carrying toothed wheels (34, 36) cooperating with the toothed wheels of drive shaft (12) and of driven shaft (38).

Two motion transmission tracks (T1, T2) are found between drive shaft (12) and driven shaft (38) comprising a toothed wheel (14, 42) carried by the drive shaft. The driven shaft through a one-way clutch (20, 46), a toothed wheel (34, 36) fixedly carried by the intermediate motion transmission shaft and a toothed wheel (16, 40) is connected to the drive shaft and to the driven shaft by a disengageable clutch (18, 44).

### CROSS REFERENCE TO RELATED APPLICATIONS

Reference is made to patent to International Application No. PCT/EP2015/062022 and French Patent Application No. 14/54.987, which applications are incorporated herein by reference in their entirety.

### BACKGROUND OF THE INVENTION

1. Field of the Invention

The present invention relates to a speed transmission for moving a two wheeled motor vehicle, and to a powertrain using this transmission.

2. Description of the Prior Art

French Patent 2,811,395 describes a speed transmission comprising a drive shaft arranged substantially parallel to a driven shaft that is generally used for driving the drive wheel of the vehicle. In this type of transmission, the drive shaft is driven in rotation by the thermal engine and it fixedly carries two toothed wheels which are each in gear with driven toothed wheels carried by the driven shaft and mounted idle on this shaft. This driven shaft also carries alternate-clearance sliding gears allowing the driven toothed wheels to be secured in rotation to this shaft. Thus, in operation, the vehicle is driven at different speeds by acting upon the various sliding gears carried by the driven shaft to secure one of the toothed wheels of the drive shaft with one of the driven toothed wheels of this driven shaft.

As it is well known, this type of transmission can be used with a hybrid type vehicle that combines, an internal-combustion engine and a rotary driving/generator machine for moving the vehicle such as an electric machine connected to an electric source, such as one or more electric accumulators.

This combination allows optimizing the performance of the vehicle, notably by decreasing the fuel consumption of the whole device while preserving the environment through limited pollution discharged into the atmosphere.

Thus, when the vehicle is to be driven with a high torque over a wide speed range while limiting exhaust gas and noise generation, as in an urban site, the electric machine is preferably used for driving the vehicle.

On the other hand, the thermal engine is used for moving this vehicle for uses where a high driving power and a wide operating range are required.

Although satisfactory, this transmission device however involves quite significant drawbacks.

Indeed, to obtain the desired moving speed, it is necessary to couple or to uncouple some elements of the device, such as the driven toothed wheels. This consequently lengthens the gear change time, thus leading to driver discomfort.

Furthermore, the transmission device must comprise a multiplicity of actuators for controlling the sliding gears. These actuators increase the production cost of the device and can be the source of failure and/or dysfunction.

Moreover, these actuators need to be controlled by a processing unit such as the engine calculator, which requires increasing the capacity of the calculator.

The present invention overcomes the aforementioned drawbacks by providing of a simple and inexpensive speed transmission device.

### SUMMARY OF THE INVENTION

The invention relates to a transmission for motor vehicles, notably two-wheeled motor vehicles, comprising a drive shaft carrying at least two driving toothed wheels, a driven shaft carrying at least two driven toothed wheels and an intermediate motion transmission shaft carrying toothed wheels cooperating with the toothed wheels of the drive shaft and of the driven shaft, wherein the transmission comprises two motion transmission tracks located between the drive shaft and the driven shaft comprising a toothed wheel carried by the drive shaft and the driven shaft through a one-way clutch, a toothed wheel fixedly carried by the intermediate shaft and a toothed wheel connected to the drive shaft and to the driven shaft by a disengageable clutch.

One of the tracks can comprise a driving toothed wheel carried by the drive shaft through a one-way clutch, a toothed wheel fixedly carried by the intermediate motion transmission shaft and a driven toothed wheel connected to the driven shaft by a disengageable clutch.

The other track can comprise a symmetrical arrangement of the toothed wheels with respect to the track with a driving toothed wheel carried by the drive shaft through a disengageable clutch, a toothed wheel fixedly carried by the intermediate motion transmission shaft and a driven toothed wheel connected to the driven shaft by a one-way clutch.

The transmission can comprise a band closed upon itself and linking the toothed wheels of each motion transmission track to each other.

The band closed upon itself can comprise a chain.

The band closed upon itself can comprise a belt.

The one-way clutch can comprise a free wheel.

The disengageable clutch can comprise a controlled clutch.

The disengageable clutch can comprise an automatic clutch.

The driven shaft can comprise a connecting toothed wheel for transmission of the rotating motion from the driven shaft to any desired equipment.

The invention also relates to a powertrain, notably for a motor vehicle, comprising an internal-combustion engine, a speed transmission and a drive track, comprising a speed transmission as mentioned above.

The powertrain can comprise a driving/generator machine at least for moving the vehicle.

The powertrain can comprise a drive track with a disengageable clutch and the rotor of the machine is linked to the clutch.

The rotor of the machine can be linked to the intermediate shaft.

The rotor of the machine can be linked to a closed band.

The rotor of the machine can be linked to the drive shaft.

The rotor of the machine can be linked to the pressure plate of the disengageable engine clutch.

The powertrain can comprise a closed band for rotationally connecting the rotor of the machine and the element driven.

### BRIEF DESCRIPTION OF THE FIGURES

Other features and advantages of the invention will be clear from reading the description hereafter, given by way of non limitative example, with reference to the accompanying figures wherein:

FIG. 1 is a diagram showing the speed transmission according to the invention;

FIG. 2 shows a variant of the speed transmission of Figure ;

FIGS. 3 and 4 are diagrams illustrating details of variant of the speed transmission of FIG. 2;

FIG. 5 shows a variant of the speed transmission of FIG. 2;

FIG. 6 is a diagram of the speed transmission of FIG. 2 used in a powertrain;

FIG. 7 illustrates the variant of the speed transmission of FIG. 6 applied to a hybrid type vehicle;

FIG. 8 shows a variant of FIG. 7;

FIG. 9 is a variant of FIG. 8;

FIG. 10 illustrates another variant; and

FIG. 11 illustrates a variant of FIG. 10.

### DETAILED DESCRIPTION

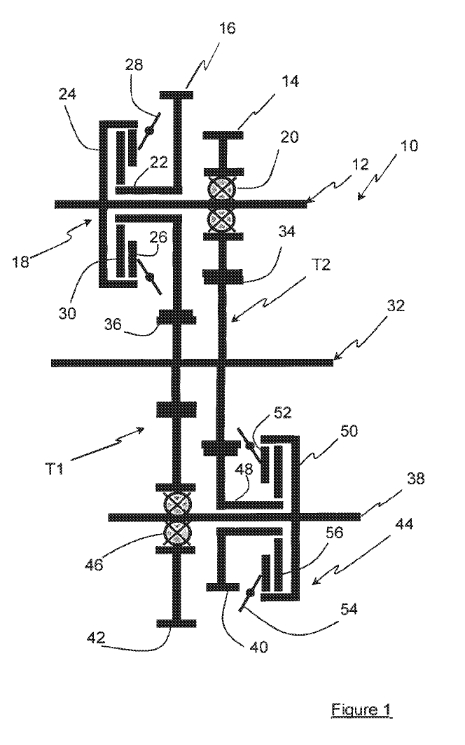

As illustrated in FIG. 1, speed transmission 10 comprises a drive shaft 12 carrying two toothed wheels of different diameter 14 and 16, and a disengageable clutch 18.

Considering FIG. 1, toothed wheel 14 (referred to as small toothed wheel) is arranged on drive shaft 12 by interposing a one-way clutch 20, such as a free wheel. To the left of this small toothed wheel, the other toothed wheel 16 (or large toothed wheel) is arranged on a sleeve 22 surrounding shaft 12 while being free in rotation on this shaft but fixed in translation. A disengageable clutch 18, which is a controlled disengageable clutch, such as a friction disc clutch, comprises a reaction plate 24 fixed on the shaft, a pressure plate 26, free in translation but fixed in rotation with the reaction plate, whose motion towards the reaction plate is controlled in any known way, such as levers 28, and a friction disc 30 free in translation on sleeve 22 but fixed in rotation by being arranged between the pressure plate and the reaction plate.

For simplification reasons, in the rest of the description, toothed wheels 14 and 16 are referred to as driving toothed wheels.

This device also comprises an intermediate rotating motion transmission shaft 32, positioned substantially parallel to drive shaft 12 and carrying two toothed wheels 34 and 36 fixed on this shaft of different diameter, meshing with the toothed wheels of the drive shaft. Toothed wheel 34 (intermediate large toothed wheel) of this connecting shaft cooperates with the small driving toothed wheel and toothed wheel 36 (intermediate small toothed wheel) cooperates with the large driving toothed wheel.

This device furthermore comprises, substantially parallel to drive shaft 12 and to intermediate shaft 32, a driven shaft 38 that carries, like drive shaft 12, two toothed wheels 40 and 42 of different diameter and a controlled disengageable clutch 44, which is a friction disc clutch.

The toothed wheels and the clutch are positioned on the driven shaft symmetrically to the drive shaft.

Thus, toothed wheel 42 (large driven toothed wheel) is arranged on shaft 38 through a one-way clutch 46, such as a free wheel, and toothed wheel 40 (small driven toothed wheel) is arranged on a sleeve 48 surrounding driven shaft 38 while being free in rotation on this shaft but fixed in translation. As with clutch 18 of the drive shaft, disengageable clutch 44 is here a friction clutch with a reaction plate 50 fixed on the driven shaft, a pressure plate 52 free in translation but fixed in rotation with the reaction plate, the motion thereof towards the reaction plate being controlled by any known means, such as levers 54, and a friction disc 56 free in translation on sleeve 48 but fixed in rotation.

As can be better seen in, large driven wheel 42 meshes with small intermediate wheel 36 while small driven wheel 40 meshes with large intermediate wheel 34.

Of course, without departing from the scope of the invention, disengageable clutches 18 and 44 are not limited to friction disc clutches as described above. They may be automatic clutches such as centrifugal clutches.

In this configuration, the transmission device comprises two gear trains forming two rotating motion transmission tracks T1 and T2 between the drive shaft and the driven shaft. One of these tracks T1 comprises large driving toothed wheel 16, small intermediate toothed wheel 36 and large driven wheel 42. The other track T2 symmetrically comprises small driving toothed wheel 14, large intermediate wheel 34 and small driven wheel 40.

Of course, it is known in the art to provide known devices such as hydraulic, electric or mechanical actuators for actuating levers 28 and 54 according to the desired gear ratio.

The device described above provides four gear ratios using two clutches and two free wheels.

In one of these gear ratios, upon rotation of the drive shaft and in disengaged position of the two clutches 18 and 44, small driven toothed wheel 14 is driven in rotation through the actuation of free wheel 20 connecting the drive shaft and this wheel. This rotation of wheel 14 is then transmitted to intermediate shaft 32 by large intermediate toothed wheel 34, which causes small intermediate toothed wheel 36 to be driven in rotation. This small wheel in turn drives large driven wheel 42 which retransmits this rotation to driven shaft 32 through the action of free wheel 46.

Of course, as the two clutches are inactive, neither large driving toothed wheel 16 nor small driven wheel 40 is driven in rotation by the drive shaft or the driven shaft, and they idle on shafts 12 and 38.

In another gear ratio, clutch 18 of the drive shaft is in engaged position and clutch 44 of the driven shaft is in disengaged position. Large driving wheel 16 is then driven in rotation by drive shaft 12 through the action of clutch 18. This rotation is retransmitted to intermediate shaft 32 by small intermediate wheel 36 which communicates it to large driven wheel 42. The rotation of this large wheel is transmitted to the driven shaft through the actuation of free wheel 46.

Simultaneously, the rotation of intermediate shaft 32 by the small intermediate wheel causes the rotation of large intermediate wheel 34, which in turn drives small driving wheel 14. Considering the rotating speed differential between drive shaft 12 and small driving wheel 14, this shaft is uncoupled from the small driving wheel by the inaction of free wheel 20.

For another gear ratio, clutch 44 of driven shaft 38 is in engaged position and clutch 18 of drive shaft 12 is in disengaged position. Small driving wheel 14 is then driven in rotation by the drive shaft through free wheel 20. The rotation of this small driving wheel is communicated to intermediate shaft 32 by large intermediate wheel 34 which transmits it to the driven shaft of small driven wheel 40 through the action of clutch 44.

The rotation of intermediate shaft 32 through large intermediate wheel 34 causes the rotation of small intermediate wheel 36 that meshes with large driven toothed wheel 42. However, considering the rotating speed differential between driven wheel 42 and driven shaft 38, the latter is uncoupled from the large driven wheel by the inaction of free wheel 46.

Finally, for the last gear ratio, both clutches 18 and 44 are in engaged position. The rotation of drive shaft 12 is transmitted, through the action of clutch 18, to large driving wheel 16 which transmits it to small intermediate toothed wheel 36 of intermediate shaft 32 which transmits this rotation to small driven wheel 40 through large intermediate toothed wheel 34. The driven shaft is then driven in rotation through the action of clutch 44 connecting the small driven toothed wheel to this shaft.

In this configuration, the rotation of intermediate shaft 32 also causes, through the intermediate toothed wheels 34 and 36, the rotation of small driving toothed wheel 14 and of large driven toothed wheel 42. As already mentioned, considering the rotating speed differential between drive shaft 12 and the small driving wheel, this shaft is uncoupled from the small driving wheel by free wheel 20. Likewise, the driven shaft is uncoupled from large driven wheel 42 by free wheel 46 considering the rotating speed differential between the driven wheel and the driven shaft.

Thus, the transmission as described above provides four gear ratios with automatic disconnection by free wheels of the driving wheel and/or of the driven wheel in the first three gear ratios.

This transmission also allows different gear ratios when using the toothed wheels of each transmission track T1 or T2, or to combine part of the toothed wheels of one of the tracks T1 with part of the other track T2 so as to have other gear ratios.

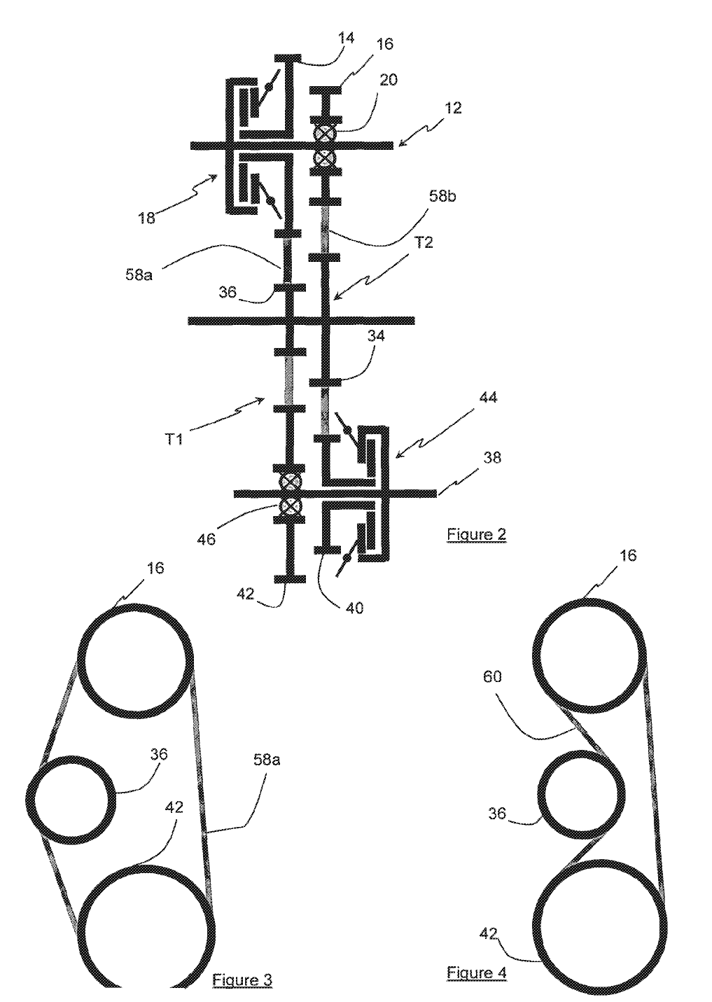

In the variant of FIG. 2, the different wheels of each rotating motion transmission track T1 and T2 are not connected to one another through meshing (as illustrated in FIG. 1) but by a closed band, such as a chain or a belt, preferably internally and/or externally notched.

As can be better seen in FIG. 2, a chain is provided for each transmission track, a chain 58a for connecting large driving toothed wheel 16, small intermediate toothed wheel 36 and large driven toothed wheel 42 (see also FIG. 2), and a chain 58b for connecting small driving wheel 14, large intermediate toothed wheel 34 and small driven wheel 40.

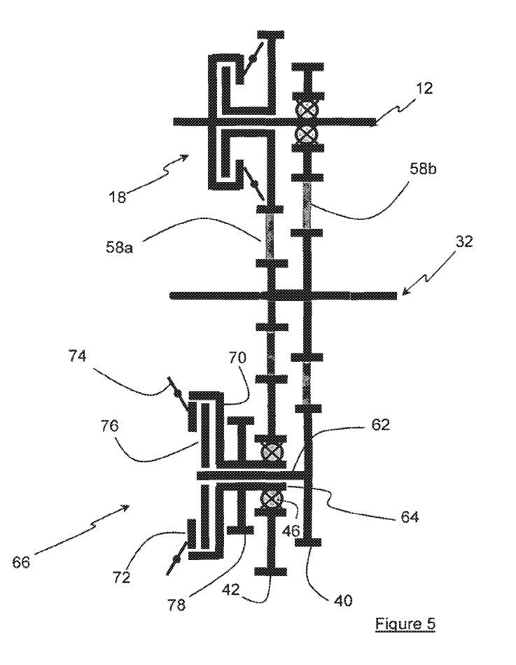

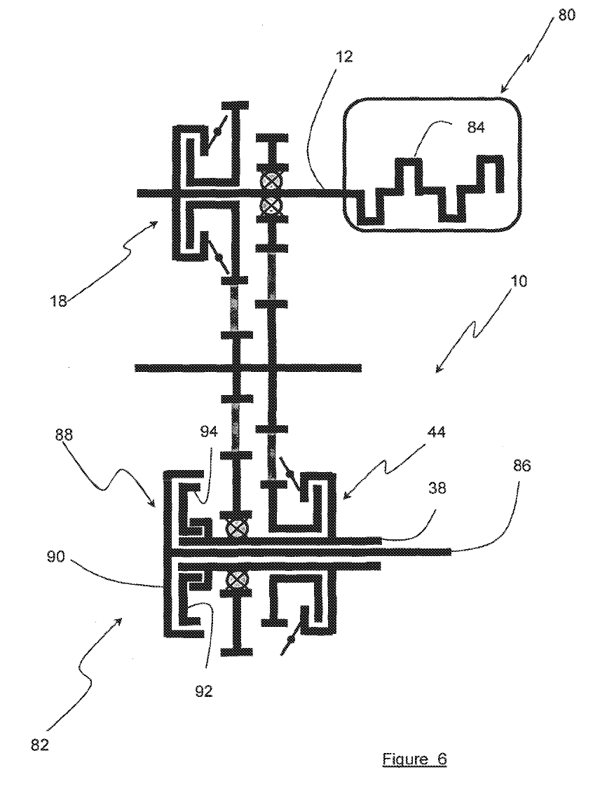

As illustrated in FIG. 4, this chain can be replaced by an internally or externally notched belt 60 that cooperates with wheels provided with supplementary notches.

This variant operates identically to the device of FIG. 1, with the possibility of obtaining four gear ratios.

In both use cases (chain or belt), this enables modifying the location of the shafts and to position them at a distance from one another, according to the available space, while providing transmission of the rotating motion between these shafts.

Furthermore, this chain (or this belt) allows limiting friction with the wheels in comparison to the layout of FIG. 1 where these wheels mesh with one another.

Moreover, the manufacture of wheels 14, 16, 34, 36, 40 and 42 are less expensive when using a chain or a belt, in comparison to the manufacture of gears as described in FIG. 1.

Using a chain or a belt can also allow avoiding having a wet sump of lubricating solutions.

The variant of FIG. 5 differs from the embodiment of FIG. 2 in that the disengageable clutch (disc clutch) of the driven shaft is positioned on the same side as disengageable clutch 18 of drive shaft 12.

More precisely, small driven toothed gear 40 is fixedly carried by a pin 62 running through a tubular part 64 fixed in translation with respect to this pin and on which free wheel 46 carrying large driven wheel 42 rests. This tubular part carries a disengageable clutch 66 allowing pin 62 to be connected to this tubular part.

As in the previous embodiments, this disengageable clutch comprises a reaction plate 70 fixed on tubular part 64, a pressure plate 72, free in translation but fixed in rotation with the reaction plate, whose motion towards the reaction plate is controlled by levers 74, and a friction disc 76 free in translation and fixed in rotation on pin 62 while being positioned between the reaction plate and the pressure plate.

Thus, the driven shaft of the transmission device is composed of tubular part 64 that advantageously carries a fixed connecting toothed wheel 78 for transmission of the rotating motion of this driven shaft to any desired equipment.

The operation of this variant is identical to that of FIG. 1 while making it possible to obtain four gear ratios with automatic disconnection by free wheels of driving wheel 42 and/or driven wheel 14.

FIG. 6 illustrates the application of speed transmission 10 to a powertrain of a motor vehicle such as a two-wheeled motor vehicle.

This powertrain thus comprises an internal-combustion engine 80, speed transmission 10 and a drive track 82 of the vehicle.

As is visible in this figure, drive shaft 12 of device 10 is connected to crankshaft 84 of the internal-combustion engine.

Driven shaft 38 of device 10 is here a hollow shaft in which drive shaft 86 of the drive track is housed. This drive shaft is directly or indirectly connected to the drive wheel(s) of the vehicle by any known means. The drive track also comprises a centrifugal clutch 88 with a plate 90 fixedly carried by drive shaft 86 of the drive track and a web 92 fixedly connected to driven shaft 38 and carrying friction flyweights 94 subjected to the centrifugal force.

Therefore, through the rotation of driven shaft 38 resulting from one of the gear ratios, the web is caused to rotate. Under the effect of this rotation of the web, flyweights 94 come into contact with plate 90, thus establishing a rotatable link between the driven shaft and drive shaft 86 of drive track 82.

Of course, without departing from the scope of the invention, the centrifugal type automatic clutch can be replaced by any other controlled disengageable clutch such as a disc clutch.

The operation of speed transmission device 10 for the powertrain of FIG. 6 is the same as in FIG. 1.

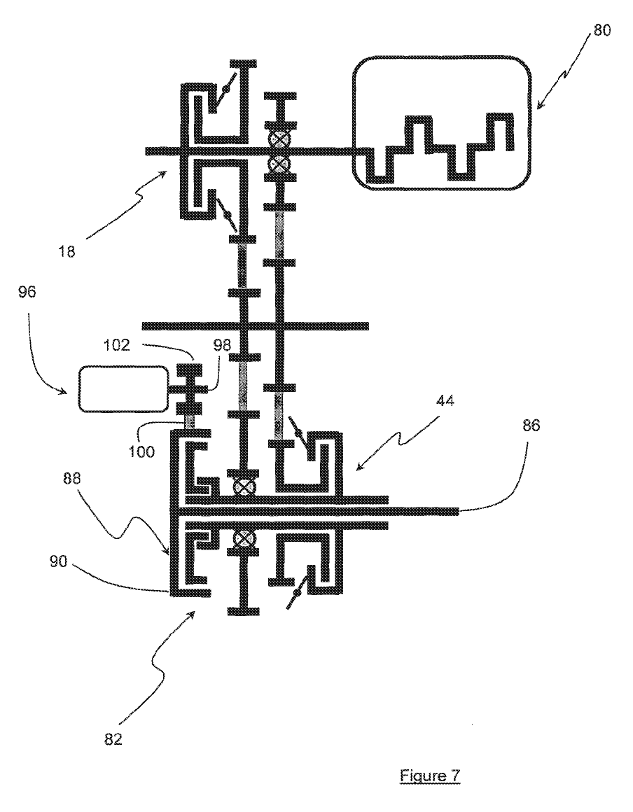

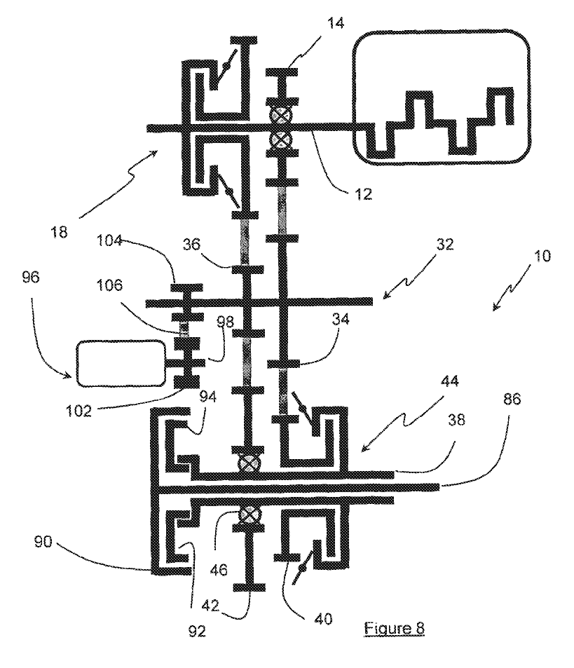

FIG. 7 is a variant of FIG. 6 with a specific application of the transmission device to a powertrain for a hybrid type vehicle where a driving/generator machine 96 is associated with internal-combustion engine 80.

This machine is, only by way of example in the rest of the description, a hydraulic machine or an electric machine powered by batteries (not shown) which is used either as an electric motor for moving the vehicle or as a generator for charging the batteries or for supplying power to the electrical accessories of the vehicle.

As can be better seen in FIG. 7, the electric machine comprises a rotor 98 rotationally connected with plate 90 of centrifugal clutch 88 of drive track 82.

By way of example, this connection is provided by a chain (or a notched belt) connecting a toothed wheel 102 carried by the rotor to plate 90.

This connection can also be achieved through the cooperation of toothed wheel 102 of the rotor with supplementary teeth (not shown) carried by the periphery of plate 90.

It is therefore possible to achieve motion of the vehicle in forward gear or in reverse gear through the rotation of rotor 98 that is transmitted to plate 90 and to drive shaft 86 of the drive track.

During purely electric operation for moving the vehicle, only the electric motor is used. This electric motor can also be used in combination with internal-combustion engine 80, for either providing supplementary power to drive shaft 86 of track 82, or for use as a generator for recharging the batteries.

Furthermore, upon vehicle deceleration, the rotor of machine 96 is driven in rotation by plate 90 of the centrifugal clutch and, in this case, the machine becomes a generator.

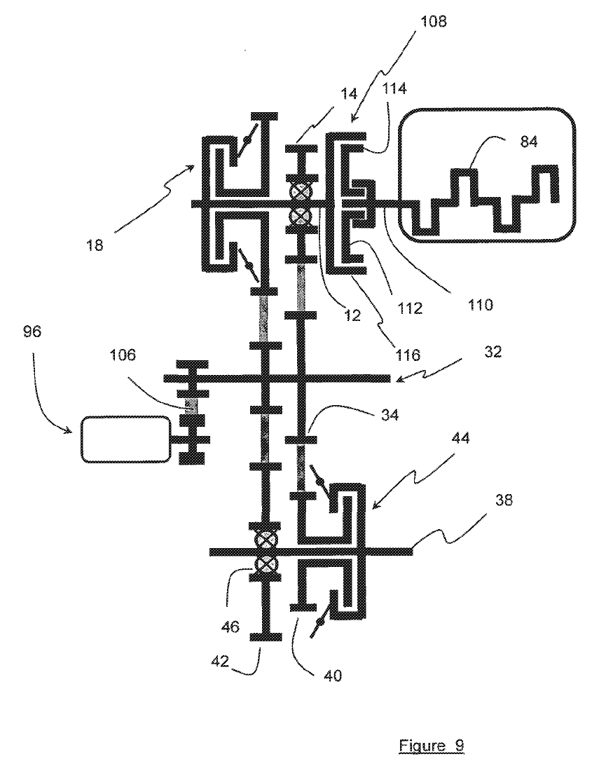

In the variant of FIG. 8, electric machine 86 is rotationally connected to intermediate shaft 32 of transmission device 10.

This is achieved by arranging fixedly a toothed wheel 104 on this shaft and by connecting this toothed wheel to toothed wheel 102 of rotor 98 through a chain 106 (or a notched belt). It is also possible to directly connect toothed wheel 102 of the rotor to toothed wheel 104 of shaft 32.

Thus, in purely electric operation for moving the vehicle, it is possible to move this vehicle with two gear ratios.

One of these ratios results from the transmission of the rotation of the machine rotor to shaft 32 by chain 106, then through the rotation of small intermediate toothed wheel 36 that is transmitted to large driven wheel 42. The rotation of this driven wheel is communicated to shaft 38 through free wheel 46, then to web 92. This rotation of the web actuates flyweights 94 which establish a connection with plate 90 and drive shaft 86 of drive track 82.

Of course, for this gear ratio, disengageable clutches 18 and 44 are not active and drive shaft 12 cannot be driven in rotation by small driving wheel 14 due to the speed differential between drive shaft 12 and this driving wheel.

For the other gear ratio, disengageable clutch 18 remains inactive and the other disengageable clutch 44 is active by establishing a connection between driven shaft 38 and small driven wheel 40.

The rotation of large intermediate wheel 34 is transmitted to this small driven wheel that drives in rotation tubular driven shaft 38 through clutch 44. The rotation of shaft 38 is transmitted to web 92, thus providing actuation of flyweights 94 which establish a connection with plate 90 and drive shaft 82.

In this gear ratio, small driving toothed wheel 14 cannot drive shaft 12 in rotation due to the speed differential between drive shaft 12 and this driving wheel, and large driven wheel 42 is not driven in rotation by the tubular shaft due to the speed differential between tubular driven shaft 38 and this large driven wheel carried thereby.

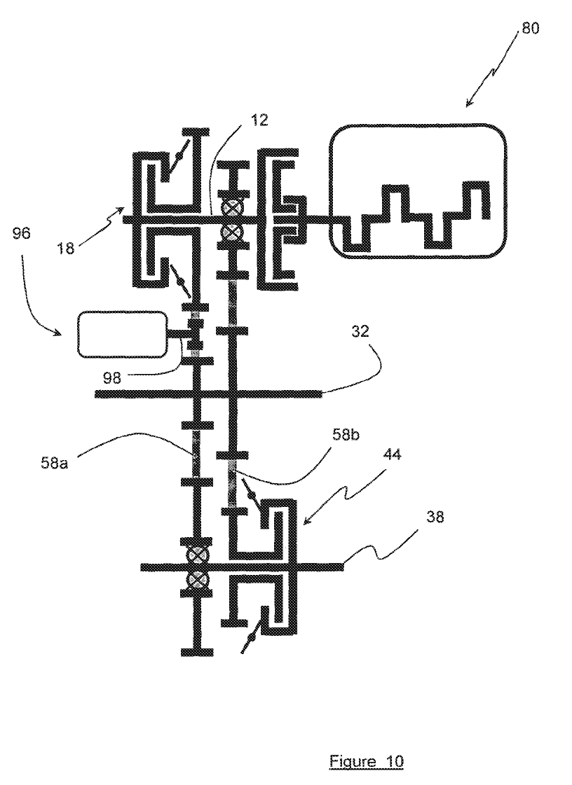

The variant of FIG. 9 arranges a centrifugal clutch 108 between crankshaft 84 of internal-combustion engine 80 and drive shaft 12.

This centrifugal clutch comprises a driving shaft 110 connected to crankshaft 84 of the internal-combustion engine, a web 112 connected to this driving shaft and carrying friction flyweights 114 subjected to the centrifugal force to come into contact with a plate 116 carried by drive shaft 12.

Of course, as already mentioned, the centrifugal type automatic clutch can be replaced by any other controlled disengageable clutch such as a disc clutch.

As in the example of FIG. 8, in purely electric operation for moving the vehicle, it is possible to achieve two gear ratios.

One of these gear ratios results from the transmission of the rotation of the machine rotor to shaft 32 through chain 106, then through the rotation of small intermediate toothed wheel 36 which is transmitted to large driven wheel 42. The rotation of this driven wheel is communicated to driven shaft 38 through free wheel 46.

Of course, for this gear ratio, the internal-combustion engine is not operational, which consequently uncouples the crankshaft from drive shaft 12. Similarly, disengageable clutches 18 and 44 are not active, and small driving wheel 14 is not driven in rotation by drive shaft 12.

For the other gear ratio, the internal-combustion engine is still not operational, disengageable clutch 18 remains inactive and the other disengageable clutch 44 is active by establishing a connection between driven shaft 38 and small driven wheel 40.

The rotation of large intermediate wheel 34 is transmitted to this small driven wheel which transmits it to clutch 44 and driven shaft 38.

In this gear ratio, small driving wheel 14 and large driven wheel 42 are not driven in rotation by drive shaft 12 and driven shaft 38 respectively.

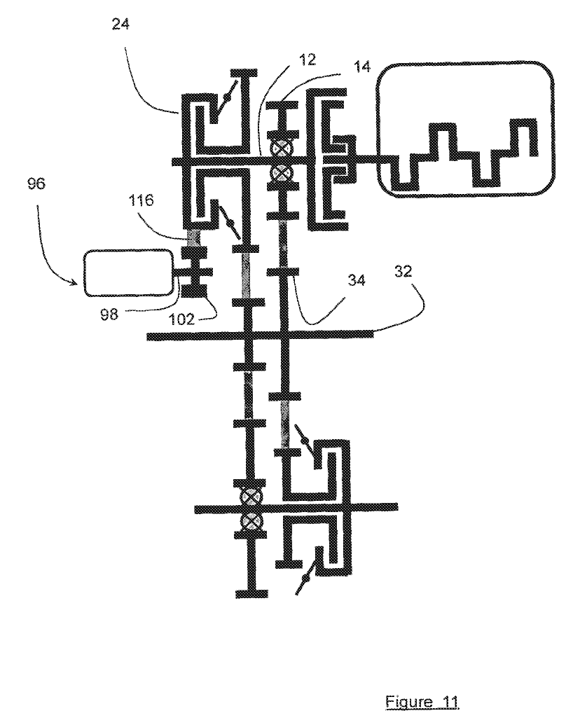

The variant of FIG. 10 differs from FIG. 9 in that rotor 98 of machine 96 is connected by its toothed wheel 102 to one of chains 58a or 58b, here chain 58a, connecting the driving toothed wheels to the intermediate toothed wheels and the driven toothed wheels.

This advantageously allows housing machine 96 in a multiplicity of locations considering the available space, while enabling two gear ratios to be achieved as mentioned above in FIGS. 8 and 9.

Alternatively, as illustrated in the variant of FIG. 11, rotor 98 of machine 96 is connected, by a closed band 116 (chain or notched belt), to drive shaft 12 through pressure plate 24.

This connection can also be achieved through the cooperation of toothed wheel 102 of the rotor with supplementary teeth (not shown) carried by the periphery of plate 24.

This has the effect of transmitting the rotation of the rotor to either small driving wheel 14 which transmits it to intermediate shaft 32 through large intermediate wheel 34 when clutch 18 is in disengaged position, or to large driving wheel 16, through clutch 18 when it is in engaged position, which transmits it to small intermediate wheel 36.

In this configuration, in purely electric operation for moving the vehicle, it is possible to achieve four gear ratios as described above in connection with FIGS. 1 and 2.

1-18. (canceled)

19. A transmission for two wheeled motor vehicles, comprising a drive shaft carrying at least two driving toothed wheels, a driven shaft carrying at least two driven toothed wheels and an intermediate motion transmission shaft carrying toothed wheels cooperating with the toothed wheels of the drive shaft and of the driven shaft, and wherein the transmission comprises two motion transmission tracks between the drive shaft and the driven shaft comprising a toothed wheel carried by the drive shaft and the driven shaft through a one-way clutch, a toothed wheel fixedly carried by the intermediate motion transmission shaft and a toothed wheel connected to the drive shaft and to the driven shaft by a disengageable clutch.

20. A transmission device as claimed in claim 19, wherein one of the tracks comprises a driving toothed wheel carried by drive shaft through the one-way clutch, a toothed wheel fixedly carried by the intermediate motion transmission shaft and a driven toothed wheel connected to the driven shaft by the disengageable clutch.

21. A transmission as claimed in claim 19, comprising another track including toothed wheels symmetrically disposed with respect to het tracks including a driving toothed wheel carried by the drive shaft through the disengageable clutch, a toothed wheel fixedly carried by the intermediate motion transmission shaft and a driven toothed wheel connected to the driven shaft by the one-way clutch.

22. A transmission as claimed in claim 20, comprising another track including toothed wheels symmetrically disposed with respect to het tracks including a driving toothed wheel carried by the drive shaft through the disengageable clutch, a toothed wheel fixedly carried by the intermediate motion transmission shaft and a driven toothed wheel connected to the driven shaft by the one-way clutch.

23. A transmission as claimed in claim 19, wherein the transmission comprises a closed band linking the toothed wheels of each intermediate motion transmission track to each other.

24. A transmission as claimed in claim 20, wherein the transmission comprises a closed band linking the toothed wheels of each intermediate motion transmission track to each other.

25. A transmission as claimed in claim 21, wherein the transmission comprises a closed band linking the toothed wheels of each intermediate motion transmission track to each other.

26. A transmission as claimed in claim 22, wherein the transmission comprises a closed band linking the toothed wheels of each intermediate motion transmission track to each other.

27. A transmission as claimed in claim 23, wherein the closed band comprises a chain.

28. A transmission as claimed in claim 23, wherein the closed band comprises a belt.

29. A transmission as claimed in claim 19, wherein the one-way clutch comprises a free wheel.

30. A transmission as claimed in claim 20, wherein the one-way clutch comprises a free wheel.

31. A transmission as claimed in claim 21, wherein the one-way clutch comprises a free wheel.

32. A transmission as claimed in claim 23, wherein the one-way clutch comprises a free wheel.

33. A transmission as claimed in claim 27, wherein the one-way clutch comprises a free wheel.

34. A transmission device as claimed in claim 19, wherein the disengageable clutch comprises a controlled clutch.

35. A transmission device as claimed in claim 19, wherein the disengageable clutch comprises an automatic clutch.

36. A transmission device as claimed in claim 19, wherein the driven shaft comprises a connecting toothed wheel which transmits rotary motion from the driven shaft.

37. A transmission as claimed in claim 19, comprising a powertrain including an internal-combustion engine, a speed transmission and a drive track.

38. A transmission as claimed in claim 37, comprising a machine for moving a vehicle.

39. A power train as claimed in claim 37, wherein drive track comprises a disengageable clutch, including a rotor is linked to the disengageable clutch.

40. A powertrain as claimed in claim 39, wherein the rotor is linked to the intermediate transmission motion shaft.

41. A powertrain as claimed in claim 39, wherein the rotor is linked to a closed band.

42. A powertrain as claimed in claim 39, wherein the rotor is linked to the drive shaft.

43. A powertrain as claimed in claim 21, wherein the rotor is linked to a pressure plate of the disengageable engine clutch.

44. A powertrain as claimed in claim 39, comprising a closed band for rotationally linking the rotor and to a driven element.
